(19) United States
(12) Patent Application Publication
(10) Pub. No.: US 2009/0120922 A1
(43) Pub. Date: May 14, 2009

(54) Ceramic Body and Steel Post Locating Pin Assembly

(75) Inventor: David E. Schutte, Lynnville, TN (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., DETROIT, MI (US)

(21) Appl. No.: 11/937,515

(22) Filed: Nov. 9, 2007

(51) Int. Cl. B23K 37/06

(52) U.S. Cl. 219/158

(57) ABSTRACT

A composite locating pin adapted for interconnection with a welding apparatus, securing a plurality of workpieces in a fixed relative condition, and resisting slag adhesion, deformation and pin failure, during a welding cycle, includes, in a preferred embodiment, a removable pin body formed of a technical ceramic, a pin post formed of a steel alloy, and an adhesive layer intermediate the body and post, wherein the body and post are cooperatively configured so as to be removably yet securely interfitted in an assembled condition, and the layer is configured so as to further secure the pin in the assembled condition.

### BACKGROUND OF THE INVENTION

1. Field of the Invention

The present invention relates to locating pins for use during resistance welding of workpieces, and more particular pertains to a composite locating pin, such as an assembly comprising a technical ceramic pin body and steel alloy post, adapted for use with a welding apparatus.

2. Discussion of Prior Art

It is known in the welding arts to utilize locating pins to precisely secure a plurality of workpieces in a fixed relative condition during welding. In addition to or in lieu of clamping, these pins are typically inserted within coaxially aligned preformed holes defined by the workpieces near the welding location to ensure that the workpieces have been properly positioned and prevent relative lateral motion during welding. FIG. 1 shows a typical prior art configuration of a locating pin 1, wherein a tapered portion 1a (i.e., pin body) is inserted within a hole defined by a plurality of workpieces, a radially larger stop portion 1b engages the lower workpiece, and a remaining lower post portion 1c is removably connected to a securing apparatus.

The development of conventional pins has historically relied upon iron-based materials, such as steel. While providing the necessary strength to withstand anticipatory and inadvertent forces during welding, the use of these materials has resulted in various manufacturing concerns. For example, it is known in the art for steel locating pins to adhere to weld spatter (i.e., slag), which can cause a pin to lose its tight dimensional tolerance. Further, a weld-spatter coated pin can damage the workpiece or make its loading to and unloading from welding fixtures difficult. Once contaminated, the pin may also compromise the workspace resulting in damage to other machinery. Another concern arises when the workpiece consists of harder material, such as a heavier grade of steel, than the pin material. In this regard, it is appreciated that sharp edges on the workpiece can deform the pin by “grooving” its exterior, further resulting in excessive wear (e.g., ringing of the pin) and/or imprecision.

To address these concerns, locating pins have been developed with anti-weld spatter coating and/or in conjunction with an insulation sleeve/barrier. However, these coatings and barriers have been subject to degradation by large quantities of heat and welding grease encountered during the welding process. Moreover, the costs associated with producing coated locating pins have resulted in low market penetration, and sleeves may further require substantial retrofitting.

High temperature resistant and non-conductive ceramic locating pins have more recently been developed to address these concerns, and present the state of the art. The hardness characteristics of ceramic make these pins resistant to deformation and averse to weld slag adhesion. In one true line application, a ceramic pin was found to exhibit only slight deformation due to welding explosion after 250,000 cycles (or three years), while a steel pin used in the same application exhibited substantial deformation due to grooving and weld-spatter after only 6,600 cycles (or one month). Ceramic pins, however, fail to provide the same shear and tensile strengths that sustain lateral welding forces encountered during welding as their steel counterparts. As a result, though weld-spatter and grooving are minimized, complete pin failure (i.e., the fracturing of the pin post) has increased in frequency.

Thus, there remains a need in the art for a non-conductive locating pin that both is resistant to deformation and weld spatter, and provides the necessary shearing and tensile strengths to sustain anticipatory and inadvertent welding loads.

### BRIEF SUMMARY OF THE INVENTION

Responsive to these concerns and need, the present invention involves a composite locating pin for use with existing welding apparatus that combines the strengths of iron-based and ceramic material characteristics. The composite pin results in a locating pin that is non-conductive, does not adhere to weld slag, is resistant to pin body deformation (including grooving), and is able to sustain the anticipatory and inadvertent forces encountered during welding. As a result, the benefits of this invention include extending pin life, and reducing down time and maintenance associated with the use of conventional locating pins. The inventive pin is particularly useful in areas where changing elements is difficult or dangerous.

In general, a composite welding pin adapted for use with a welding apparatus and for locating and securing a plurality of workpieces in a fixed relative condition during a welding cycle, is disclosed herein. The pin comprises a pin body formed of a first material generally resistant to abrasion and adhesion to slag formed during the cycle. The pin body is electrically and thermally insulative. The pin further includes a post formed of a second material having lateral bending, tensile and shearing strengths greater than the first material. The post is configured to be securely interconnected with the apparatus. Finally, the body and post are mated pairs, and cooperatively configured so as to be securely interfitted in an assembled condition.

Other aspects and advantages of the present invention, including preferred embodiments of the pin body and post assembly will be apparent from the following detailed description of the preferred embodiment(s) and the accompanying drawing figures.

### BRIEF DESCRIPTION OF THE SEVERAL VIEWS OF THE DRAWING

A preferred embodiment(s) of the invention is described in detail below with reference to the attached drawing figures, wherein:

FIG. 1 is an elevation view of a prior art locating pin securing a plurality of workpieces during a welding cycle, particularly illustrating an integral pin and apposite clamping member, as well as dual-electrode welding in hidden-line type;

FIG. 2 is a perspective view of composite locating pins laterally securing a plurality of workpieces in a fixed relative position;

FIG. 3 is an exploded elevation of a locating pin in accordance with a preferred embodiment of the present invention, particularly illustrating a pin body defining a body cavity, and a pin post presenting an inserting member and removably connected to a welding apparatus;

FIG. 3a is a birds-eye view of the pin shown in FIG. 3;

FIG. 3b is a cross-sectional view of the pin body shown in FIG. 3 taken along line A-A;

FIG. 3c is an elevation view of the pin shown in FIG. 3, in an assembled condition;

FIG. 4 is a cross-sectional view of a pin body in accordance with a preferred embodiment of the present invention, wherein the cavity defines a polygonal cross-sectional shape;

FIG. 5 is a cross-sectional view of a pin body in accordance with a preferred embodiment of the present invention, wherein the cavity defines a star-shaped cross-section; and

FIG. 6 is an exploded elevation of a locating pin in accordance with a preferred embodiment of the present invention, particularly illustrating a pin body defining a tapped body cavity, and a pin post presenting a threaded inserting member.

### DETAILED DESCRIPTION OF THE INVENTION

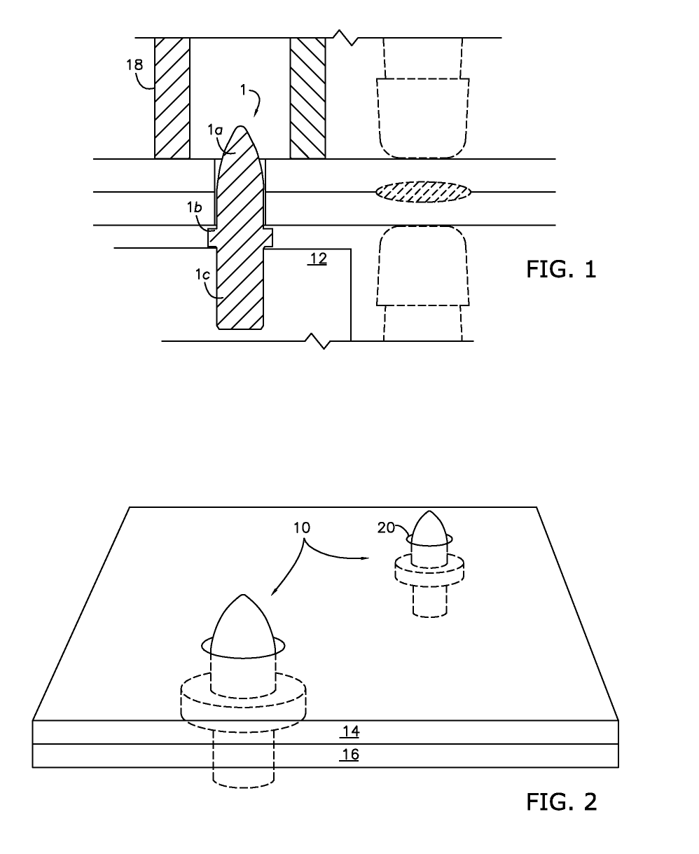

The present invention concerns a composite locating pin 10 adapted for use with existing welding systems, such as the dual electrode resistance spot welding apparatus 12, shown in FIG. 1. The inventive pin 10 is described and illustrated herein with respect to resistance welding; however, it is certainly within the ambit of the invention to utilize the aspects and benefits thereof, wherever a locating pin is to encounter high quantities of heat energy, slag, and/or lateral forces during a welding or otherwise bonding process. As shown in FIGS. 1 and 2, the pin 10 is configured for generally locating and securing a plurality of workpieces 14,16 in a relatively fixed lateral condition during a welding cycle, and a precise absolute position when the workpieces are further secured by clamping fixture 18 (FIG. 1).

To accomplish this task, the workpieces 14,16 each define a pre-formed opening 20 that are co-axially aligned only when the workpieces are in the proper position for welding (hence it is appreciated that a minimum plurality of two pins and two sets of openings 20 are required for absolute relative positioning). The composite pin 10, like its prior art counterparts, is cooperatively configured with the openings 20, so as to be facilely, yet tightly, received therein, where tolerance is determinable based on application and pin taper configuration. For example, where a 10.1 mm (+0.10,−0.00 mm) diameter opening 20 is defined by the workpieces, the preferred pin 10 presents a maximum inserted diameter not greater than 10.0 (+0.00,−0.10 mm), and not less than 9.99 mm. As shown in FIG. 1, the clamping fixture 18 may present a distal portion defining an endless wall or tubular member that circumscribes the pin 10 when engaging the workpieces 14,16. It is further appreciated that where the clamping fixture 18 also presents a welding electrode and an annular weld is proximately produced around the pin 10, the benefits of the present invention are magnified.

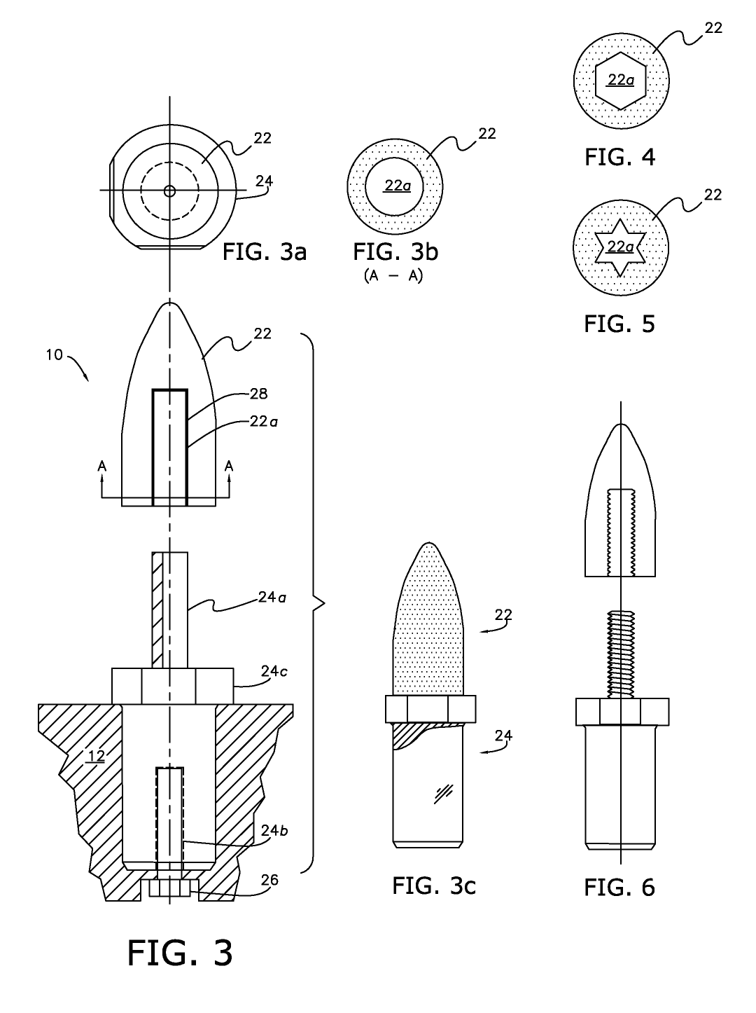

As best shown in FIGS. 3 and 3c, the composite assembly includes a pin body 22 and a pin post 24. Since it presents the portion of the pin 10 that is inserted within the openings 20, and is most proximate to weld formation, the body 22 is formed of a first material generally resistant to deformation and adhesion to the slag. The material is also generally non-conductive and thermally insulative (i.e., resistant to heat flow). The preferred pin body material is a material selected from an exemplary group consisting of technical ceramics.

More particularly, the preferred pin body material is non-wetting for most non-ferrous metals at temperatures up to 1000° C. (i.e., 1832° F.), is not degradable by aggressive melts, and is resistant to attack from fluxing salts and chlorine at 800° C. (i.e., 1472° F.). For example, the first material may exhibit the following minimum properties:

| | |
|---|---|
| 3 point room temperature modulus of rupture | 945 MPa |
| Weibull modulus | 11 |
| Room temperature unit tensile strength | 450 Mpa |
| Room temperature compressive strength | 3500 Mpa |
| Room temperature Young's modulus of elasticity | 288 Gpa |
| Room temperature hardness (HRA) | 92 |
| Fracture toughness (K1c) | 7.7 Mpa m½ |
| Poisson's ratio | 0.23 |
| Density | 3.23 × 103 Kgm−3 |
| Thermal expansion coefficient (0-1200° C.) | 3.04 × 10−6 K−1 |
| Specific heat | 620 Jkg−1 K−1 |
| Room temperature thermal conductivity | 21.3 Wm−1 K−1 |

Accordingly, a pin body material suitable for use in the present invention is a fine grain, densely fused and chemically inert technical ceramic, such as Syalon® 101 by Consolidated Ceramic Products of Blanchester, Ohio. Again, however, it is appreciated that functionally equivalent materials may be utilized.

As shown in FIGS. 3 and 6, the post 24 is configured to be securely interfitted with the body 22 in an assembled condition, and provide structural support to the body 22 during the welding process. As such, the post 24 sustains the anticipatory and inadvertent lateral forces encountered during the welding process, as it is appreciated that these forces exert stresses upon the pin 10 as workpieces are loaded and unloaded over a plurality of cycles, and are typically the cause of premature pin failure. In its supportive role, the post 24 is formed of a second material having torsional, lateral bending, tensile and/or fatigue strengths greater than those presented by the first material. The post 24 is not exposed to weld slag or in direct engagement to the sharp edges of the openings 20, so that the second material need only provide the necessary strengths. In a preferred embodiment the post 24 is formed to universal standards, such as the North American Automotive Metric Standards (NAAMS), so as to be interchangeable with prior art pin body and welding/fixture technology. More specifically, the post 24 is configured for use with various sizes of existing pin bodies ranging, for example, from 20 mm to 40 mm in length and 8 mm to 30 mm in width.

A suitable pin post material for use in the present invention is an iron-based material, such as steel, and more preferably 4140 alloy steel. However, it is appreciated that other related metals or functionally equivalent materials (respective to strength) could be utilized instead of 4140 steel. The post 24 is configured so that the pin 10 can be securely interconnected with the apparatus 12, and more preferably includes a billet insertable within a recessed holding socket within or hole defined by the apparatus 12 (FIG. 3). In this configuration, the post 24 is secured to the apparatus 12 preferably by a bolt fastener 26, and as such preferably defines a mated tapped hole 24b (FIG. 3). In the illustrated embodiment, the billet may present an M10 mm×1.5 thread pitch×25 mm depth NAAMS standard hole 24b for securing the post 24 to industry standard apparatuses. More preferably, the pin 10 is magnetized for further securing to the apparatus 12.

The pin body 22 and post 24 are securely interfitted to represent an assembled condition, and more preferably present mated pairs. In this regard, the body defines a longitudinal cavity 22a and the post 24 presents an insertable elongated member 24a. The cavity 22a and member 24a are cooperatively configured so that the member 24a is tightly receivable within the cavity 22a, wherein “tightly receivable” shall mean generally within a tolerance of 6 0.10 mm. Where the body 22 presents distal ends and a longitudinal body length therebetween, the member 24 preferably extends within the cavity 22a a distance not less than one-half, and more preferably three-quarters, the body length.

As shown in FIGS. 3-3b, the cavity 22a and member 24a present congruent three-dimensional shapes wherein the member 24a is slightly smaller (e.g., presents a scaling of 95 to 98 percent). It is appreciated that the tight tolerance prevents the body 22 from excessively floating during workpiece loading, welding, and unloading. Thus, while upward removal and replacement of the pin body 22 is enabled, relative lateral motion is generally prevented. For example, for a 10 mm o.d. pin body, the cavity may present a cylindrical shape having a cross-sectional diameter within a range of 4 to 8 mm, and more preferably, equal to 6.00 mm (+0.10,−0.00 mm), and the member 24 may present a cylindrical element having a corresponding cross-sectional diameter within a range 3.75 to 7.75 mm, and more preferably, equal to 5.75 mm (+0.10,−0.00 mm).

Alternatively, the cavity 22a and member 24a may present polygonal cross-sectional shapes, so as to prevent relative rotational motion, when the member 24a is inserted into the cavity 22a (FIG. 4). In another alternative, the cavity 22a and member 24a may present congruent star shaped cross-sections, so as to further prevent relative rotational motion therebetween (FIG. 5). Finally, in yet another alternative illustrated by FIG. 6, the body 22 may present a tapped cavity 22a, and the post 24 a threaded member 24a. In this configuration, it is appreciated that relative lateral and incidental rotational motion are further prevented, upward motion (such as unwarranted dislodgements) is prevented, and the pin 10 presents an adjustable total height.

In a preferred embodiment, a locking mechanism 28, such as Loctite®, or a similar adhesive, is provided to help hold the pin 22 and post 24 in the assembled condition. As best shown in FIGS. 2 and 3, a stop 24c is also presented by a section of the post 24 having a larger diameter than that of the openings 20 so as to prevent the passage of the pin 10. The workpieces 14,16 are able to rest upon the stop 24c, such that the workpieces are spaced from the often greasy and otherwise contaminated fixtures. Section 24c is preferably configured for engagement with a wrench or hand tool, so as to facilitate affixing (e.g., bolting) to and removal from the welding apparatus 12. For example, the stop 24c may present flat tool engaging surfaces, as best shown in FIG. 3a. Finally, where the body 22 and post 24 cooperatively define a longitudinal co-axis and first and second pin ends in the assembled condition, the stop 24c is preferably equally spaced from the ends.

The preferred forms of the invention described above are to be used as illustration only, and should not be utilized in a limiting sense in interpreting the scope of the general inventive concept. Obvious modifications to the exemplary embodiments and methods of operation, as set forth herein, could be readily made by those skilled in the art without departing from the spirit of the present invention. The inventor hereby states his intent to rely on the Doctrine of Equivalents to determine and assess the reasonably fair scope of the present invention as pertains to any system or method not materially departing from but outside the literal scope of the invention as set forth in the following claims.

What is claimed is:

1. A composite locating pin adapted for use with a welding apparatus and for locating and securing a plurality of workpieces in a fixed relative condition during a welding cycle, wherein slag is generated, said pin comprising:
a pin body formed of a first material generally resistant to deformation and adhesion to the slag, wherein said first material is electrically and thermally insulative; and
a post formed of a second material having lateral bending, tensile and shearing strengths greater than the first material, and configured to be securely interconnected with the apparatus,
said body and post being mated pairs, and cooperatively configured so as to be securely interfitted in an assembled condition.

2. The pin as claimed in claim 1, further comprising:
a locking mechanism configured to hold the pin and post in the assembled condition.

3. The pin as claimed in claim 2, wherein the mechanism includes loctite.

4. The pin as claimed in claim 2, wherein said body defines a longitudinal cavity, the post presents an elongated member, and said cavity and member are cooperatively configured so that at least a portion of the member is receivable within the cavity.

5. The pin as claimed in claim 4, wherein the body presents a longitudinal body length, and the member extends within the cavity a distance not less than one-half the body length.

6. The pin as claimed in claim 4, wherein the cavity and member present congruent polygonal cross-sectional shapes, and the member is tightly receivable within the cavity, so as to prevent relative rotational motion, when the member is inserted into the cavity.

7. The pin as claimed in claim 4, wherein the cavity and member present congruent star shaped cross-sections, and the member is tightly receivable within the cavity, so as to prevent relative rotational motion, when the member is inserted into the cavity.

8. The pin as claimed in claim 4, wherein the cavity is tapped and the member is threaded, so that the member is adjustably inserted within the cavity.

9. The pin as claimed in claim 1, wherein the first material is a technical ceramic.

10. The pin as claimed in clam 1, wherein the second material is 4140 steel alloy.

11. The pin as claimed in claim 1, wherein the body and post cooperatively define a longitudinal co-axis and first and second ends in the assembled condition, and a stop spaced from the ends.

12. The pin as claimed in claim 1, wherein the stop is equally spaced from the ends.

13. The pin as claimed in claim 4, wherein the cavity defines a constant cross-sectional diameter equal to 6.00 mm, and the member presents a constant cross-sectional diameter equal to 5.75 mm.

14. A composite locating pin adapted for use with a welding apparatus and for locating and securing a plurality of workpieces in a fixed relative condition during a welding cycle, wherein slag is generated, said pin comprising:
a pin body formed of a first material generally resistant to deformation and adhesion to the slag, wherein said first material is electrically and thermally insulative;
a post formed of a second material having lateral bending, tensile and shearing strengths greater than the first material, and configured to be securely interconnected with the apparatus, said body and post being mated pairs, and cooperatively configured so as to be securely interfitted in an assembled condition; and
a locking mechanism configured to hold the pin and post in the assembled condition,
said body defining a longitudinal cavity,
said post presenting an elongated member,
said cavity and member being cooperatively configured so that at least a portion of the member is receivable within the cavity, the cavity defines a constant cross-sectional diameter within a range of 4 to 8 mm and the member presents a constant cross-sectional diameter within a corresponding range of 3.75 to 7.75 mm.

15. A composite locating pin adapted for use with a welding apparatus and for locating and securing a plurality of workpieces in a fixed relative condition during a welding cycle, wherein slag is generated, said pin comprising:
a pin body formed of a technical ceramic;
a post formed of a steel alloy, and defining a tapped hole so as to be securely connected to the apparatus by a bolt fastener; and
a loctite adhesive layer intermediate surfaces defined by the body and post,
said body and post being mated pairs, and cooperatively configured so as to be securely interfitted in an assembled condition.
